(19) United States
(12) Patent Application Publication
(10) Pub. No.: US 2011/0307118 A1
(43) Pub. Date: Dec. 15, 2011

(54) Vehicle Aerodynamic Efficiency Advisor Systems and Methods

(75) Inventors: Wade W. Bryant, Grosse Pointe Farms, MI (US); Brian V. Castillo, Royal Oak, MI (US)

(73) Assignee: GM GLOBAL TECHNOLOGY OPERATIONS, INC., Detroit, MI (US)

(21) Appl. No.: 12/813,815

(22) Filed: Jun. 11, 2010

(51) Int. Cl. G06F 7/00; G06N 5/02

(52) U.S. Cl. 701/1; 706/54

(57) ABSTRACT

A method is provided. The method includes estimating aerodynamic efficiency values of a vehicle; comparing the aerodynamic efficiency values to determine vehicle settings; and generating a recommendation based on the at least one of the efficiency values and the vehicle settings.

### FIELD OF THE INVENTION

The disclosure relates to aerodynamics of a vehicle, and more particularly to methods and systems for estimating aerodynamic information and advising a vehicle driver based thereon.

### BACKGROUND

In some cases, it is not understood by a driver of a vehicle how their actions can affect the aerodynamic efficiency of the vehicle. For example, driving the vehicle with the windows down or with the sun roof open impacts the aerodynamic efficiency. Accordingly, it is desirable to provide a way for understanding the aerodynamic efficiency of the vehicle.

### SUMMARY OF THE INVENTION

In one exemplary embodiment, a method is provided. The method includes estimating aerodynamic efficiency values of a vehicle; comparing the aerodynamic efficiency values to determine vehicle settings; and generating a recommendation based on the at least one of the efficiency values and the vehicle settings.

The above features and advantages and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a functional block diagram of a vehicle including an aerodynamic efficiency system in accordance with an exemplary embodiment;

FIG. 2 is a dataflow diagram illustrating an aerodynamic efficiency system in accordance with an exemplary embodiment;

FIG. 3 is an illustration of an aerodynamic efficiency advisor in accordance with an exemplary embodiment; and

FIGS. 4 and 5 are flowcharts illustrating aerodynamic efficiency methods in accordance with exemplary embodiments.

### DESCRIPTION OF THE EMBODIMENTS

The following description is merely exemplary in nature and is not intended to limit the present disclosure, application, or uses. It should be understood that throughout the drawings, corresponding reference numerals indicate like or corresponding parts and features. As used herein the terms module and sub-module refer to an application specific integrated circuit (ASIC), an electronic circuit, a processor (shared, dedicated, or group) and memory that executes one or more software or firmware programs, a combinational logic circuit, and/or other suitable components that provide the described functionality.

In accordance with an exemplary embodiment, a vehicle that includes an aerodynamic efficiency system is shown generally at 10. The exemplary aerodynamic efficiency system is shown to include an aerodynamic efficiency module 12, one or more vehicle control modules 14, one or more vehicle components 18, and a display 16. Such vehicle components 18 can include, but are not limited to, window systems, sunroof systems, moonroof systems, other controlled systems that may impact the aerodynamic efficiency of the vehicle 10, and systems that impact the power usage of the vehicle 10 such as, for example, heating ventilation and air conditioning (HVAC) systems. As can be appreciated, the vehicle 10 can be an engine powered vehicle, an electric powered vehicle, or a hybrid engine/electric powered vehicle.

Generally speaking, the aerodynamic efficiency module 12 estimates aerodynamic effects of various vehicle settings. The aerodynamic efficiency module 12 utilizes onboard vehicle data such as, vehicle speed, route information, ambient temperature, cabin temperature, wind, or weather conditions to estimate aerodynamic data. Such onboard vehicle data can be sensed from the vehicle 10, received from other modules (i.e. engine control module, transmission control module, powertrain control module, navigation module, etc.) on the vehicle 10 via a vehicle communication bus 20, and/or received from an off board communication device (e.g., through a telematics system) (not shown).

Based on the aerodynamic data, the aerodynamic efficiency module 12 communicates data to the display 16 to display notices to a driver of the efficiency of the vehicle and/or recommendations on an approach to drive more efficiently while maintaining a desired interior environment. In various embodiments, the display 16 is an interactive display that receives input from the driver, such as, for example, a touch screen display. Based on the driver input, the aerodynamic efficiency module 12 can further request real-time adjustments of settings of one or more of the vehicle components 18. For example, the aerodynamic efficiency module 12 can generate control requests to the one or more vehicle control modules 14. The vehicle control module 14 can then control the vehicle component accordingly. For example, the vehicle control module 14 can generate control signals to adjust window positions (e.g., open, closed, partially opened, etc.), HVAC settings (e.g., temperature, fan speed, etc.), sunroof settings, etc.

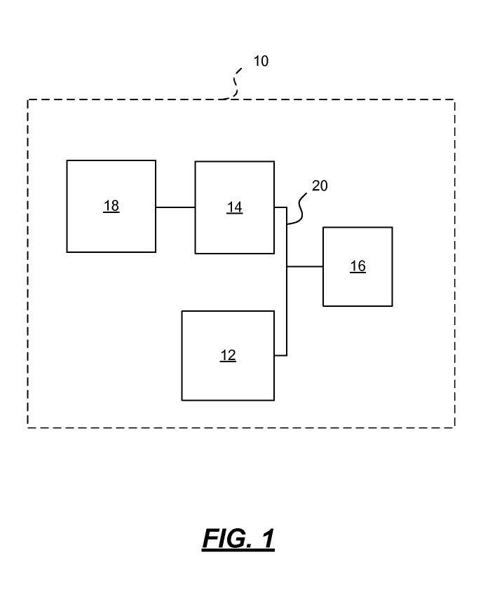

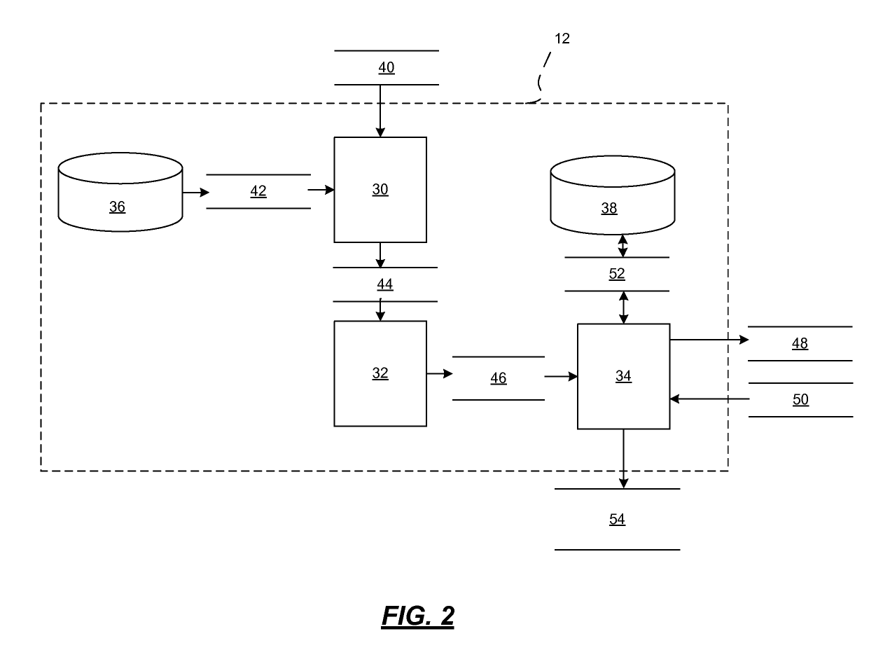

Referring now to FIG. 2, a dataflow diagram illustrates an exemplary embodiment of the aerodynamic efficiency module 12 of FIG. 1. In various embodiments, the aerodynamic efficiency module 12 can include one or more sub-modules and datastores. As can be appreciated, the sub-modules shown in FIG. 2 may be combined and/or further partitioned to similarly estimate aerodynamic data and to communicate with the display 16 (FIG. 1). Inputs to the aerodynamic efficiency module 12 can be received from the sensors of the vehicle 10 (FIG. 1), can be modeled, can be received from other control modules within the vehicle 10 (FIG. 1), and/or can be predefined. In various embodiments, the aerodynamic efficiency module 12 includes an energy estimator module 30, an efficiency estimator module 32, a display manager module 34, a parameters datastore 36, and a preferences datastore 38.

The energy estimator module 30 receives as input vehicle data 40. The vehicle data 40 indicates an estimated or measured real-time parameter of the vehicle 10. The vehicle data 40 can include, for example, but is not limited to, vehicle speed, air temperature, weather conditions, or other real-time vehicle data.

Using the vehicle data 40, the energy estimator module 30 computes energy data 44 that indicates instantaneous power consumption for various components of the vehicle 10. Such energy data 44 can include data associated with aerodynamic losses, rolling resistance losses, acceleration power, accessory loads, etc.

In various embodiments, the computations can be based on, for example, physics based models and static vehicle characteristics defined as vehicle parameters 42. The vehicle parameters can include, for example, aerodynamic drag coefficients, tire rolling resistance characteristics, vehicle mass, air-conditioner power, and frontal area. The vehicle parameters 42 can be predefined and stored in the parameters datastore 36. Using physics based models to compute the data enables the energy estimator module 30 to compute the power consumption for various modes of operation, including those not currently employed by the driver (i.e., computing power consumption with the air conditioning on when the air conditioning is actually off).

The efficiency estimator module 32 receives as input the energy data 44. The efficiency estimator module 32 determines efficiency values by computing various combinations of the energy data 44. For example, the efficiency estimator module 32 can compute efficiency values from aerodynamic losses of driving with the window up or the window down and driving with the current speed or a reduced speed.

The efficiency estimator module 32 compares the efficiency values to determine the most efficient combination (i.e., the lowest efficiency value). The efficiency estimator module 32 then determines efficiency data 46 based on the most efficient combination. In various embodiments, the efficiency data 46 can include, for example, the operation combination, the power savings related to the operation combination, a cost savings related to the operation combination, an estimated extended distance related to the operation combination, and the current vehicle data. In various embodiments, the extended distance can indicate the distance a vehicle may travel with its current charge or fuel on board (range).

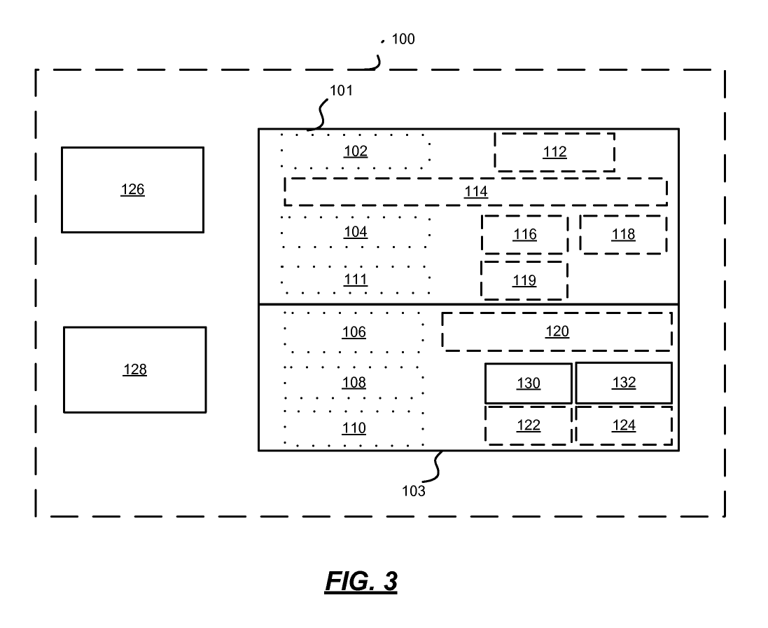

The display manager module 34 receives as input the efficiency data 46. Based on the efficiency data 46, the display manager module 34 generates display output data 48. The display output data 48 is received by the display 16 (FIG. 1) to display an interactive efficiency advisor 100 (see e.g., FIG. 3).

The display manager module 34 may further receive as input display input data 50. The display input data 50 can be generated based on a driver's interaction with the interactive efficiency advisor 100 (FIG. 3). For example, a driver can configure preferences relating to auto settings of the vehicle components 18 (FIG. 1). The display manager module 34 can store the preferences in the preferences datastore 38. When an auto setting is selected, as indicated by the display input data 50, the display manager module 34 can generate vehicle component control signals 54 based on the user preferences 52 (if provided) such that the one or more vehicle components 18 (FIG. 1) are auto controlled to achieve the recommended efficient operation.

With reference now to FIG. 3, an exemplary interactive efficiency advisor 100 is shown. In various embodiments, the interactive efficiency advisor 100 can include a current efficiency data box 101 and an auto efficiency data box 103. Each of the current efficiency data box 101 and the auto efficiency data box 103 can include one or more static text display items, one or more dynamic text display items, and one or more selection items. The static text display items can include, for example, descriptive text indicating the content of what is displayed in associated dynamic text display items. For example, text display item 102 can include “Current Vehicle Speed.” Text display item 104 can include “Predicted Savings.” Text display item 106 can include “Current Settings.” Text display item 108 can include “Adjust Preferences.” Text display item 110 can include “Comfort Bandwidth.” Text display item 111 can include “Extended Distance.”

The dynamic text display items can include, for example, dynamic text indicating the efficiency data 46 (FIG. 2). For example, text display item 112 can include the current vehicle speed. Text display item 114 can include the efficient operation combination (e.g., “closing windows and turning on the A/C will save energy”). Text display item 116 can include the cost savings (e.g., “$0.95/hr”). Text display 118 can include the power savings (e.g., “0.3 kw”). Text display item 119 can include the extended distance (e.g., “3 miles”). Text display item 120 can include the current operation (e.g., “windows closed and A/C eco mode”). Text display item 122 can include a selected temperature preference (e.g., “69-76 F”). Text display item 124 can include a selected turbulence preference (e.g., “undisturbed hair”).

The one or more selection items can include, for example, selection icons, drop-down menus, text input boxes, or other types of input items. For example, selection item 126 can include a selection icon that, when selected, displays the efficiency data 46 in the current efficiency data box 101. The selection item 126 can include a selection icon that, when selected, generates the request to auto control the vehicle components 18 (FIG. 1). The selection item 130 can include a selection icon that, when selected, configures the preferences associated with the text display 122. The selection icon 132 can include a selection icon, that when selected, configures the preferences associated with the text display 124.

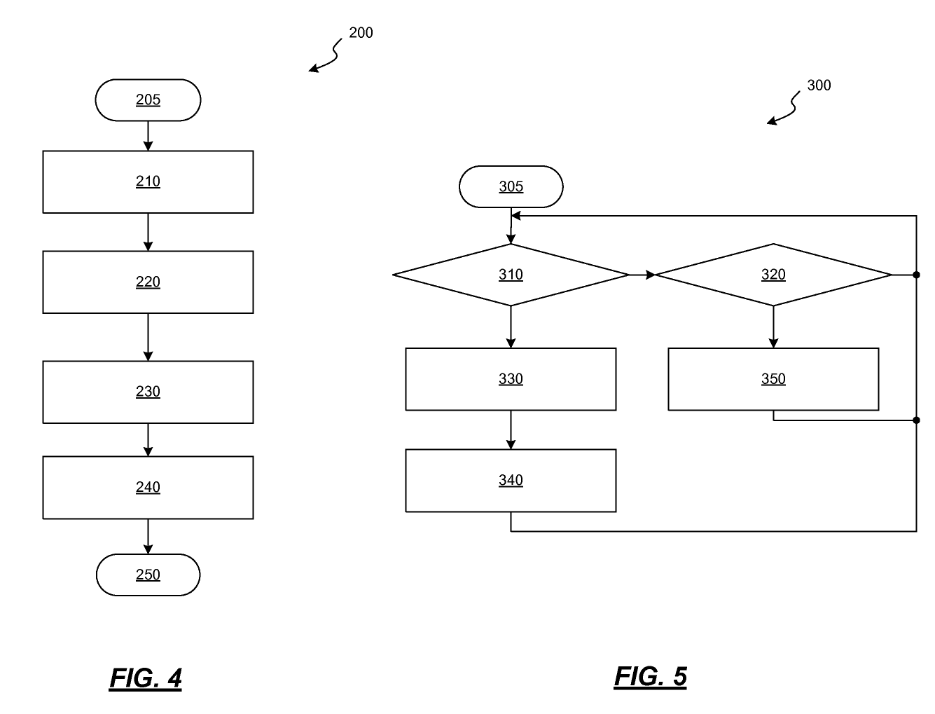

Referring now to FIGS. 4 and 5 and with continued reference to FIG. 2, flowcharts illustrate aerodynamic efficiency methods that can be performed by the aerodynamic efficiency module 12 of FIG. 2. As can be appreciated in light of the disclosure, the order of operation within the methods is not limited to the sequential execution as illustrated in FIGS. 4 and 5, but may be performed in one or more varying orders as applicable and in accordance with the present disclosure.

As can be appreciated, the aero efficiency methods can be scheduled to run based on predetermined events and/or can run at scheduled intervals during operation of the vehicle 10 (FIG. 1).

With specific reference now to FIG. 4, an efficiency monitoring method is shown generally at 200. In one example, the method may begin at 205. The energy data 44 is computed based on the vehicle parameters 42 and the real-time vehicle data 40 (e.g., the vehicle speed) at 210. The various efficiency values are computed based on combinations of the energy data 44 at 220. The efficiency values are compared for a most efficient value at 230. Based on the comparison, the efficiency data 46 is determined and displayed at 240.

With specific reference now to FIG. 5, a display input monitoring method is shown generally at 300. In one example, the method may begin at 305. Input data 50 from the display 16 is monitored at 310 and 320. If input indicating preference information is received at 310, the preferences 52 are stored at 330 and the display output data 48 is generated to display the selected preferences at 340. Thereafter, the method continues with monitoring the input from the display 16 at 310.

If, however, input indicating an auto control request is received at 320, vehicle component control signals 54 are generated based on the efficiency data 46 and the preferences 52 (if none set, then using default preferences) at 350. Thereafter, the method continues with monitoring the input from the display 16 at 310.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A method, comprising:
estimating aerodynamic efficiency values of a vehicle;
comparing the aerodynamic efficiency values to determine vehicle settings; and
generating a recommendation based on the at least one of the efficiency values and the vehicle settings.

2. The method of claim 1 wherein the estimating the aerodynamic efficiency values is based on selected vehicle settings.

3. The method of claim 1 wherein the estimating the aerodynamic efficiency values is based on unselected vehicle settings.

4. The method of claim 1 further comprising estimating savings values based on the vehicle settings, and wherein the recommendation includes the savings values.

5. The method of claim 4 wherein the savings values includes at least one of cost savings and power savings.

6. The method of claim 1 further comprising displaying the recommendation on a display of the vehicle.

7. The method of claim 1 further comprising controlling at least one vehicle component based on the vehicle settings.

8. The method of claim 7 wherein the controlling the at least one vehicle component is based on user preferences.

9. The method of claim 8 further comprising storing the user preferences entered by a user.

10. The method of claim 1 further comprising estimating an extended distance based on the vehicle settings, and wherein the recommendation includes the extended distance.

11. A vehicle control system, comprising:
a first module that estimates aerodynamic efficiency values of a vehicle, and that compares the aerodynamic efficiency values to determine vehicle settings; and
a second module that generates a recommendation based on the at least one of the efficiency values and the vehicle settings.

12. The system of claim 11 wherein the first module estimates the aerodynamic efficiency values based on selected vehicle settings.

13. The system of claim 11 wherein the first module estimates the aerodynamic efficiency values is based on unselected vehicle settings.

14. The system of claim 11 wherein the first module estimates savings values based on the vehicle settings, and wherein the recommendation includes the savings values.

15. The system of claim 14 wherein the savings values include at least one of cost savings and power savings.

16. The system of claim 11 wherein the second module displays the recommendation on a display of the vehicle.

17. The system of claim 11 further comprising a third module that controls at least one vehicle component based on the efficient vehicle settings.

18. The system of claim 11 wherein the third module controls the at least one vehicle component based on user preferences.

19. The system of claim 11 wherein the third module stores the user preferences entered by a user.

20. The system of claim 11 wherein the second module estimates an extended distance based on the vehicle settings, and wherein the recommendation includes the extended distance.

21. A vehicle, comprising:
a module that determines vehicle settings based on aerodynamic efficiency values of the vehicle; and
a display that displays a recommendation based on the vehicle settings.

22. The vehicle of claim 19 wherein the display receives input from a user indicating preferences and wherein the module determines the vehicle settings based on the preferences.

23. The vehicle of claim 19 wherein the module controls one or more vehicle components based on the vehicle settings.
